(19) United States
(12) Patent Application Publication
(10) Pub. No.: US 2015/0127604 A1
(43) Pub. Date: May 7, 2015

(54) SYSTEMS AND METHODS FOR REMOTE UPDATING OF ELECTRONIC HISTORICAL RECORDS

(71) Applicant: Otter Creek holdings, LLC, Kaysville, UT (US)

(72) Inventors: David Hudson Gunn, Kaysville, UT (US); Robert Brian Moncur, Orem, UT (US)

(73) Assignee: Otter Creek holdings, LLC, Kaysville, UT (US)

(21) Appl. No.: 14/072,275

(22) Filed: Nov. 5, 2013

(51) Int. Cl. G06F 17/30

(52) U.S. Cl. CPC G06F 17/30943
USPC 707/609

(57) ABSTRACT

A computer-implemented method for managing family history records is described. Family history data is collected. The collected family history data is compared to data in an existing family history record. Upon determining the collected family history data matches at least a portion of the data in the existing family history record, the existing family history record is updated to include at least a portion of the collected family history data.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems have opened up multiple modes of communication and increased accessibility to data. The internet allows users to post data, making the posted data available to users on wired and wireless internet connections throughout the world.

One of the multiple modes of communication opened by the internet is the genealogy industry. Genealogy is one of the most searched topics online. Opening the internet to genealogy allows genealogical data to be stored and disseminated online. Users can search census data in online databases for ancestors from around the world. However, the genealogical data generally available online does not enable users to efficiently store and disseminate data from cemeteries and landmarks. As a result, benefits may be realized by allowing users to dynamically create and update data related to cemeteries and landmarks.

### SUMMARY

According to at least one embodiment, a computer-implemented method for managing family history records is described. Family history data may be collected by a processor of a remote handheld device. The collected family history data may be compared, by the processor, to data in an existing family history record. Upon determining the collected family history data matches at least a portion of the data in the existing family history record, the existing family history record may be updated, by the processor, to include at least a portion of the collected family history data.

In one embodiment, upon determining the collected family history data does not match at least a portion of data in any existing family history record, a new family history record may be created using at least a portion of the collected family history data. Collecting the family history data may include collecting an image of a historical object, collecting location family history data from a historical object, collecting data entered on the remote device by the user, and/or collecting an audio recording of orally conveyed information regarding a historical object. The captured audio recording may be transcribed automatically by the processor.

A computing device configured to manage family history records is also described. The device may include a processor and memory in electronic communication with the processor. The memory may store instructions that may be executable by the processor to collect family history data, compare the collected family history data to data in an existing family history record, and, upon determining the collected family history data matches at least a portion of the data in the existing family history record, update the existing family history record to include at least a portion of the collected family history data.

A computer-program product to manage family history records is also described. The computer-program product may include a non-transitory computer-readable medium that stores instructions. The instructions may be executable by the processor to collect family history data, compare the collected family history data to data in an existing family history record, and, upon determining the collected family history data matches at least a portion of the data in the existing family history record, update the existing family history record to include at least a portion of the collected family history data.

According to at least one embodiment, another computer-implemented method for managing family history records is described. An existing family history record may be accessed by a processor of a remote handheld device prior to collecting family history data. The family history data may be collected by the processor. The collected family history data may be automatically associated, by the processor, with the existing family history record accessed prior to collecting the family history data. Collecting the family history data may include at least one of the following operations: collecting an image of a historical object, collecting location information of the historical object, collecting data entered on the remote device by the user, and collecting an audio recording of orally conveyed information regarding the historical object. The collected audio recording may be transcribed automatically by the processor.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of a landmark module;

FIG. 4 is a diagram illustrating an example of a device for capturing an image of a landmark;

FIG. 5 illustrates an example arrangement of detecting a feature in the depicted image of the landmark;

FIG. 6 is a flow diagram illustrating one embodiment of a method for managing a database of landmark records;

FIG. 7 is a flow diagram illustrating one embodiment of a method for managing a database of landmark records via a mobile application;

FIG. 8 is a flow diagram illustrating one embodiment of a method for modifying and creating landmark records; and

FIG. 9 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to managing records of historical objects. Historical objects may include documents such as birth certificates, death certificates, burial records, interment records. Historical objects may include photographs, heirlooms, relics, artifacts, and/or information associated with family history and/or landmarks. Landmarks may include historical landmarks such as the Statue of Liberty, the Golden Gate Bridge, etc. Landmarks may include objects such as historical and/or archeological artifacts and relics; locations such as the site of a historic battle; monuments, memorials, shrines, buildings (e.g., the Washington Monument, etc.); natural formations (e.g., the Grand Canyon); grave markers, and the like. Examples of grave markers may include headstones, tombstones, gravestones, tombs, burial vaults, architectural shrines, mausoleums, sepulchers, crypts, and any other type of marker and/or information associated with a grave (e.g., burial data sheet, interment records, etc.). Based on the determination of an individual's location (e.g., global positioning system (GPS), assisted GPS, cell tower location, triangulation, planetary alignment, astronomy, longitude-latitude, mapping, etc.), information may be retrieved and/or created in relation to a landmark. Additionally, or alternatively, in some embodiments, based on the determination of an individual's location and heading, information may be retrieved and/or created in relation to a landmark relatively near to the determined location and toward the detected heading. Examples of headings include the direction a user stands when taking a photograph (e.g., facing north), the direction a monument stands (e.g., facing east), and so forth.

In some embodiments, based on the processing of an image captured by a user, a location of the landmark may be determined. Details concerning landmark detection and related information recording is disclosed in U.S. application Ser. No. 13/763,215, filed Feb. 8, 2013, and entitled SYSTEMS AND METHODS FOR LANDMARK DETECTION, the disclosure of which is incorporated, in its entirety, by reference. In some cases, a user may add information to the captured image. For example, a user may speak information regarding the captured image while a microphone on a mobile computing device records the words spoken by the user. The system may transcribe the spoken words (e.g., speech-to-text technology). The transcribed information may be stored in association with the captured image. In another example, the user enters data (e.g., information included in or associated with the image) manually into a mobile computing device, and the data is used to update an existing record. Accordingly, an existing record may be updated with the captured image and at least a portion of the transcribed or manually entered information. In some embodiments, upon finding no existing record related to the landmark, the system may upload the data to a publicly available database and generate a new record based on the image and/or transcribed or manually entered information of the landmark, making the data available for subsequent retrieval by the user and/or other users.

The records referenced herein may include any of a variety of types of records. For example, a record may include family history information and/or genealogical information and may be referred to as a family history record and/or family history. record. Genealogical and family history records typically include information about a family or individual such as parents, siblings, children, spouse, birth and death dates and locations, marriage dates and locations, and other significant life events such as occupations, military service, awards/recognitions, and community/public service.

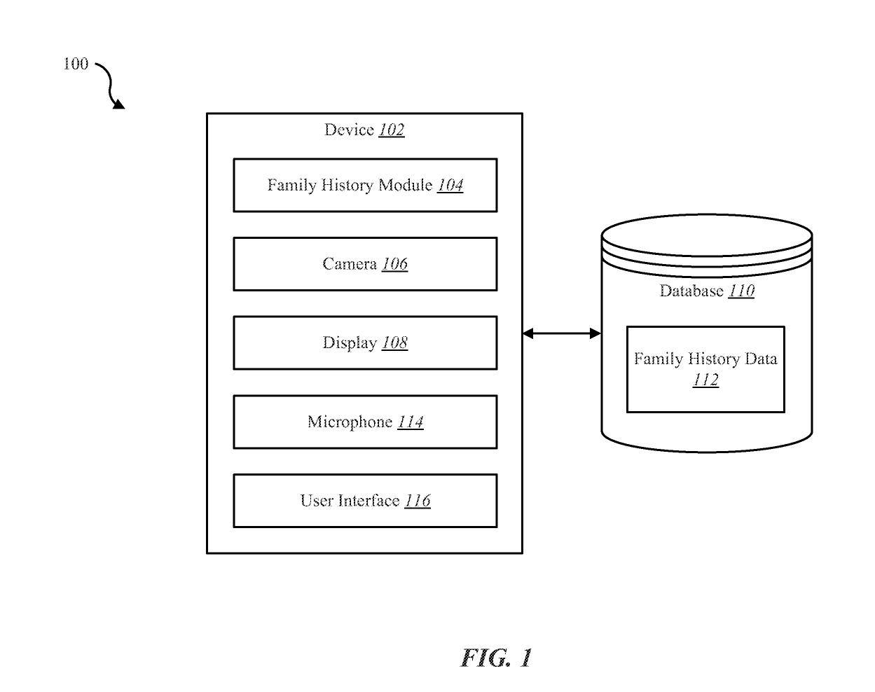

FIG. 1 is a block diagram illustrating one embodiment of an environment 100 in which the present systems and methods may be implemented. In some embodiments, the systems and methods described herein may be performed on a single device (e.g., device 102). For example, a family history module 104 may be located on the device 102. Examples of devices 102 include mobile devices, smart phones, tablet computing devices, personal computing devices, computers, servers, etc.

In some configurations, a device 102 may include a family history module 104, a camera 106, a display 108, a microphone 114, and a user interface 116. In one example, the device 102 may be coupled to a database 110. In one embodiment, the database 110 may be internal to the device 102. In another embodiment, the database 110 may be external to the device 102. In some configurations, the database 110 may include family history data 112. The family history data 112 may include, for example, an existing family history record or other stored genealogical data.

In one embodiment, the family history module 104 may enable the detection of a landmark based on location, heading, image data, manually-entered description, and/or a transcribed audio description of the landmark. In some configurations, the family history module 104 may obtain one or more images of a landmark. For example, the family history module 104 may capture an image of a landmark via the camera 106. Additionally, or alternatively, the family history module 104 may capture video images (e.g., more or less than 5 seconds of video) via the camera 106. The family history module 104 may capture a recording of an oral description of the landmark in conjunction with capturing the image of the landmark. The family history module 104 may receive manually-entered data inputted by the user. In some configurations, the family history module 104 may query the family history data 112 in relation to capturing the image, transcribing the oral description, and/or receiving the manually-entered data. For example, the family history module 104 may compare at least a portion of the transcribed oral description or manually-entered data with the family history data 112 in order to determine whether a match exists. In some embodiments, the family history module 104 may detect a location and/or heading of the user in relation to capturing the image of the landmark. For example, the family history module 104 may detect that the user is standing near a particular grave marker of a particular cemetery. In response to detecting the location and heading of the user, the family history module 104 may query the family history data 112 for a match on the particular grave marker. Upon finding a match, the family history module 104 may update the existing record with the captured image and/or at least a portion of the description of the landmark.

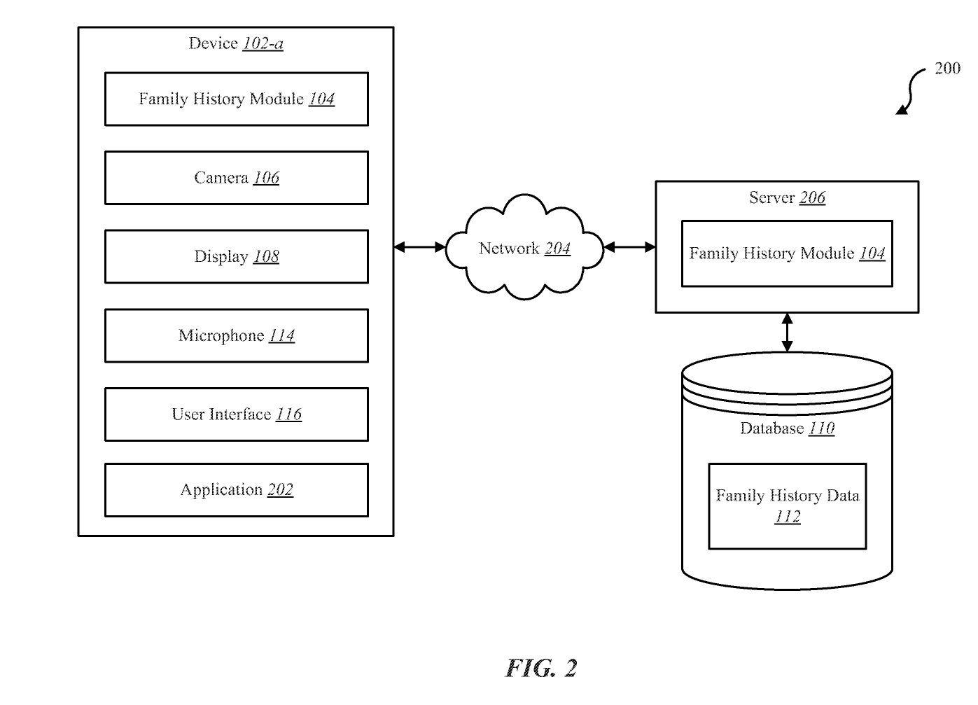

FIG. 2 is a block diagram illustrating another embodiment of an environment 200 in which the present systems and methods may be implemented. In some embodiments, a device 102-a may communicate with a server 206 via a network 204. Example of networks 204 include, local area networks (LAN), wide area networks (WAN), virtual private networks (VPN), wireless networks (using 802.11, for example), cellular networks (using 3G and/or LTE, for example), etc. In some configurations, the network 204 may include the internet. In some configurations, the device 102-a may be one example of the device 102 illustrated in FIG. 1. For example, the device 102-a may include the family history module 104, camera 106, display 108, microphone 114, user interface 116, and an application 202. It is noted that in some embodiments, the device 102-a may not include a family history module 104. For example, the device 102-a may include application 202 that enables the device 102-a to interface with the family history module 104 located on server 206. In some embodiments, both the device 102-a and the server 206 may include a family history module 104 where at least a portion of the functions of the family history module 104 are performed separately and/or concurrently on both the device 102-a and the server 206.

In some embodiments, the server 206 may be coupled to the database 110. For example, the family history module 104, from device 102-a and/or server 206, may access the family history data 112 in the database 110 via the server 206. The database 110 may be internal or external to the server 206. In some embodiments, the database 110 may be accessible by the device 102-a and/or the server 206 over the network 204.

In some configurations, the application 202 may capture multiple images via the camera 106. For example, the application 202 may use the camera 106 to capture photograph images and/or video images of a landmark. Upon capturing the one or more images, the application 202 may capture an audio description of the landmark related to the one or more images. In some cases, the application 202 may transcribe the audio description. In some embodiments, the application 202 may transmit the one or more images and/or the transcription to the server 206. In some cases, the application may transmit the audio description to the server 206 and the server 206 may transcribe the audio description.

In some configurations, the family history module 104 may capture one or more images of a landmark and determine whether the family history data 112 contains information regarding the detected landmark (e.g., location information captured by GPS). In some embodiments, the application 202 in conjunction with family history module 104 may process one or more images captured by the camera 106 in order to allow the user to enter information regarding the image. The image and entered information may be transmitted for storage at the database 110.

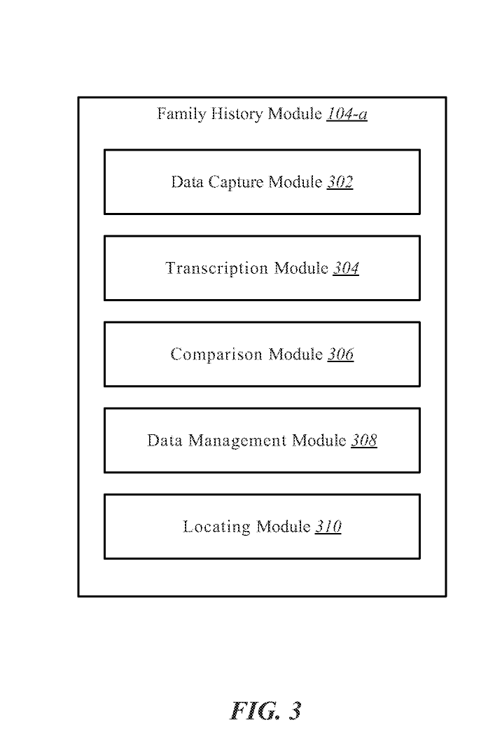

FIG. 3 is a block diagram illustrating one example of a family history module 104-a. The family history module 104-a may be one example of the family history module 104 depicted in FIGS. 1 and/or 2. As depicted, the family history module 104-a may include a detection module 304 and a database module 302.

In one embodiment, data capture module 302 may capture an image of a historical object. As explained above, the historical object may include photographs, documents such as death certificates, burial records, interment records, birth certificates, and the like. The historical object may include a landmark. In some cases, the landmark may be a grave marker. The data capture module 302 may capture spoken information. In some embodiments, the spoken information may be captured in association with capturing the image of the landmark. Transcription module 304 may be configured to transcribe the spoken information into text (e.g., using a text-to-speech algorithm). Thus, in some embodiments, family history module 104-a may enable a mobile computing device to capture an image of a landmark, to capture spoken information in association with capturing the image of the landmark, and to transcribe the spoken information into text. Accordingly, using a mobile computing device, a user may capture an image of a grave marker at a cemetery and record an audio description related to the grave marker, which the mobile computing device transcribes. The spoken information may include at least one of a name, birthdate, birthplace, date of death, place of death, information about ancestors, information about progeny, military service, occupation, hobbies, talents, and the like.

In some embodiments, family history module 104 executes a mobile application loaded on a mobile computing device, where the mobile application is configured to enable a user to capture the image of the landmark, to capture the spoken information in association with capturing the image of the landmark, and to transcribe the spoken information into text. For example, a user may execute a mobile application (e.g., application 202) acquired from a mobile “app” store. The mobile application may include a user interface (e.g., user interface 116) that enables capturing images, recording audio, transcribing recorded audio, etc. Additionally, or alternatively, the mobile application may enable a user to manage a database of landmark records such as opening existing landmark records, modifying the existing landmark records, creating new landmark records, and so forth.

In one embodiment, comparison module 306 may compare the transcribed information to one or more records in a database of landmarks (e.g., database 110). Accordingly, comparison module 306 may determine whether at least a portion of the transcribed information is associated with an existing record in the database of landmarks. For example, a user may speak the name of a person inscribed on a grave marker. After the transcription of the spoken name by the transcription module 304, the comparison module 306 may compare the transcribed name to records in a database. Upon determining at least a portion of the transcribed information is associated with an existing record, data management module 308 may update the existing record to include the captured image and/or at least a portion of the transcribed information. Upon determining at least a portion of the transcribed information is not associated with an existing record in the database, data management module 308 may create a new record for the captured image and/or the transcribed information.

In some embodiments, data management module 308 may access an existing record prior to capturing the image. For example, a user may open an existing record via the mobile application on the mobile computing device and then capture an image in association with the existing record. Thus, the mobile application may allow the user to open the existing record and update the record with new information, including manually entered data, transcribed speech-to-text data, image data, location data, and so forth. Accordingly, data management module 308 may associate a captured image with the existing record based on the user accessing the existing record prior to capturing the image.

In some embodiments, locating module 310 may determine a location in association with a landmark. For example, a global positioning system (GPS) on a mobile computing device may determine a GPS coordinate in association with capturing data (e.g., manually entering data such as by typing in information, speaking data, capturing an image of a landmark, etc.). In some cases, locating module 310 may use the location metadata embedded in an image at the time the image is captured. In some embodiments, data management module 308 may store at least a portion of the location information in a new and/or existing family history record stored in a central repository.

In some embodiments, data capture module 302 may receive manually-entered information. In some cases, the manually-entered information may be associated with capturing an image of a landmark. For example, a user may capture an image of a landmark using a mobile application. The mobile application, in conjunction with the family history module 104, may allow the user to manually enter details regarding the landmark. Accordingly, in addition to capturing an audio description (or as an alternative to capturing an audio description), data capture module 302 may capture manually-entered data and automatically associate the captured data with capturing an image of a landmark. In some cases, the captured data and/or image may be automatically associated with an existing family history record opened prior to capturing the data and/or image. In some cases, comparison module 306 may compare at least a portion of the captured data with data in existing records stored in a central repository (e.g., family history data 112 stored in database 110). Upon finding a match, at least a portion of the captured data and/or image may be automatically associated with a matching record. Otherwise, at least a portion of the captured data and/or image may be automatically added to a newly created record. Thus, data management module 308 may include at least a portion of the manually-entered information in a record associated with the image of the landmark.

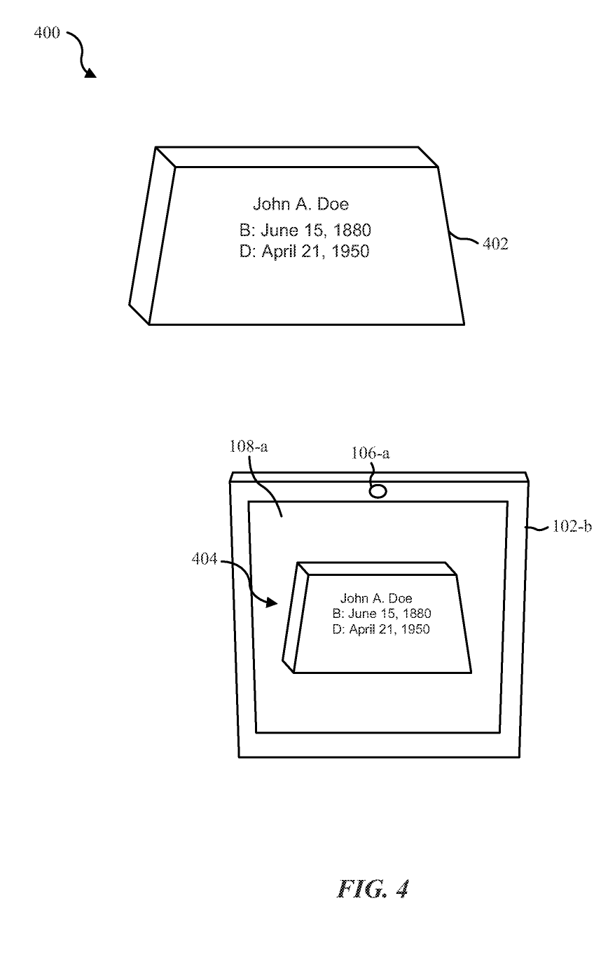

FIG. 4 is a diagram 400 illustrating an example of a device 102-b for capturing an image 404 of a historical object 402. In this example, the historical object 402 may include a landmark such as a grave marker. The device 102-b may be one example of the device 102 illustrated in FIGS. 1 and/or 2. As depicted, the device 102-b may include a camera 106-a, and display 108-a. The camera 106-a and display 108-a may be examples of the respective camera 106 and display 108 illustrated in FIGS. 1 and/or 2.

In one embodiment, the user may operate the device 102-b. For example, the application 202 may allow the user to interact with and/or operate the device 102-b. In one embodiment, the camera 106-a may allow the user to capture an image 404 of the historical object 402. As one example, the historical object 402 may include a headstone. Thus, upon the user capturing the image 404 of the headstone 402, the application 202, in conjunction with the family history module 104, may record audio of the user describing one or more features of the historical object 402. In some embodiments, the application 202, in conjunction with the family history module 104, may transcribe the audio description of the historical object 402. In some cases, the family history module 104 may detect a location and/or heading in association with the captured image. Accordingly, the application, in conjunction with the family history module 104, may send a captured image, at least a portion of an audio recording, at least a portion of a transcription of an audio recording, and/or at least a portion of location information to database 110 as part of the family history data 112.

In some embodiments, the user may query the family history data 112 for a particular existing record prior to capturing an image. For example, the user may query the system to determine whether a record already exists for “John A. Doe.” In some cases, the user may know or at least have a reasonable expectation that a particular record already exists. After finding a particular existing record, the user may proceed to take an image of the historical object 402 via the application 202. The application 202, in conjunction with the family history module 104, may automatically associate a captured image, an audio recording, a transcription, and/or location information with the particular existing record.

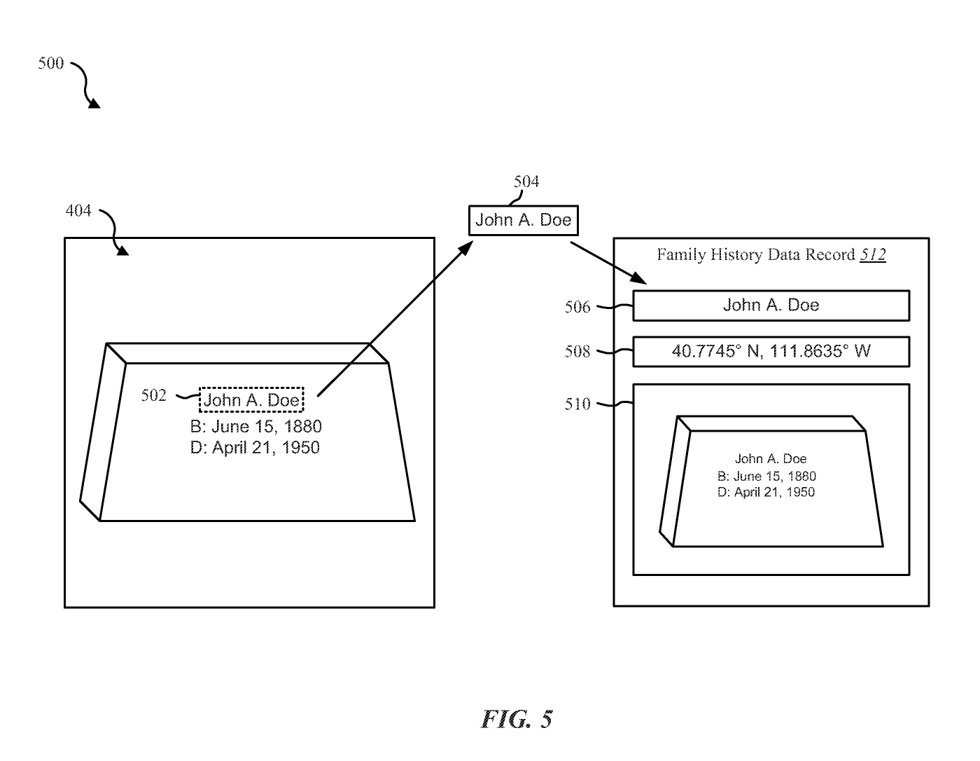

FIG. 5 illustrates an example arrangement 500 of a feature 502 described in relation to the depicted image 404 of the historical object 402 of FIG. 4. As depicted, the example arrangement 500 may include the image 404 of the historical object 402, a described feature 504, and family history data record 512. The family history data record 512 may depict one example layout of a record of the family history data 112 depicted in FIGS. 1 and/or 2. As depicted, the description may include information relating to a headstone. In other examples, the image 404 may include text from a sign, a document (such as an interment record, burial record, birth certificate, etc.), a monument, a book, and the like. In some embodiments, the described feature 504 may be the result of the family history module 104 transcribing an audio description of the historical object 402 that was captured via a user speaking into a microphone (e.g., microphone 114). In some cases, the described feature 504 may be the result of a user manually entering the description.

As described above, the image and relative data may be captured subsequent to a user looking up a particular record in the family history data record 512, whereupon the family history module 104 may automatically associate the particular record with the image and relative data. In some cases, the family history module 104 may compare the description 504 of a feature of the image 404 to one or more entries in the family history data 112. As depicted, at least one record, family history data record 512, among the family history data 112 may include a match to the described feature 504. In some embodiments, the family history data record 512 may include information related to a headstone in a cemetery. For example, the family history data record 512 may include at least name data 506, location data 508, and/or image data 510. In some embodiments, the location data 508 may include heading data. For example, the depicted record in the family history data record 512 may include heading data relating the direction that the headstone faces and/or the direction from which the image data 510 was captured (e.g., facing east). Upon finding the match, the data management module 308 may retrieve the matching record from the family history data record 512 and display one or more elements from the matching record on a computing device, such as the display 108 of the device 102 depicted in FIGS. 1 and/or 2. Accordingly, a user may provide additional details regarding the historical object 402 upon verifying what information is already included in the associated family history data record 512. The user may manually enter the additional details and/or provide the details orally, speaking the details while the family history module 104 transcribes the spoken description using speech-to-text algorithms. In some cases, the family history module 104 may provide a confirmation to the user regarding the accuracy and content of the transcription. The family history module 104 may enable the user to modify the transcription and/or add further details to the transcribed description.

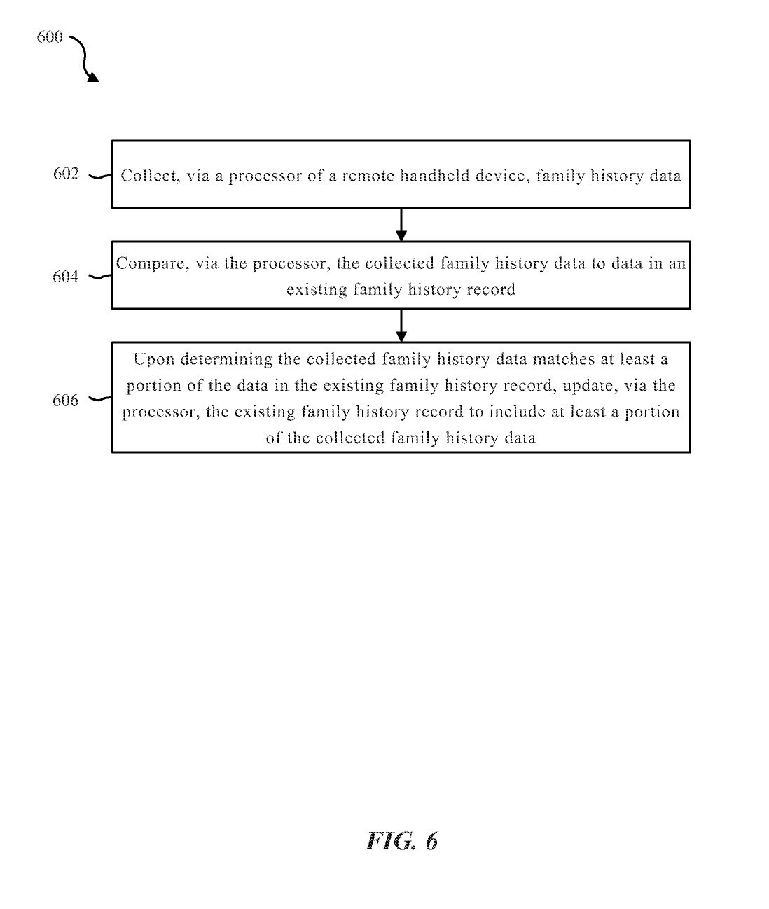

FIG. 6 is a flow diagram illustrating one embodiment of a method 600 for managing a database of landmark records. In some configurations, the method 600 may be implemented by the family history module 104 illustrated in FIGS. 1, 2, and/or 3. In some configurations, the method 600 may be implemented by the application 202 illustrated in FIG. 2.

At block 602, genealogical data may be collected via a processor of a remote handheld device. At block 604, the collected genealogical data may be compared, via the processor, to data in an existing family history record. At block 606, upon determining the collected genealogical data matches at least a portion of the data in the existing family history record, the existing family history record may be updated, via the processor, to include at least a portion of the collected genealogical data.

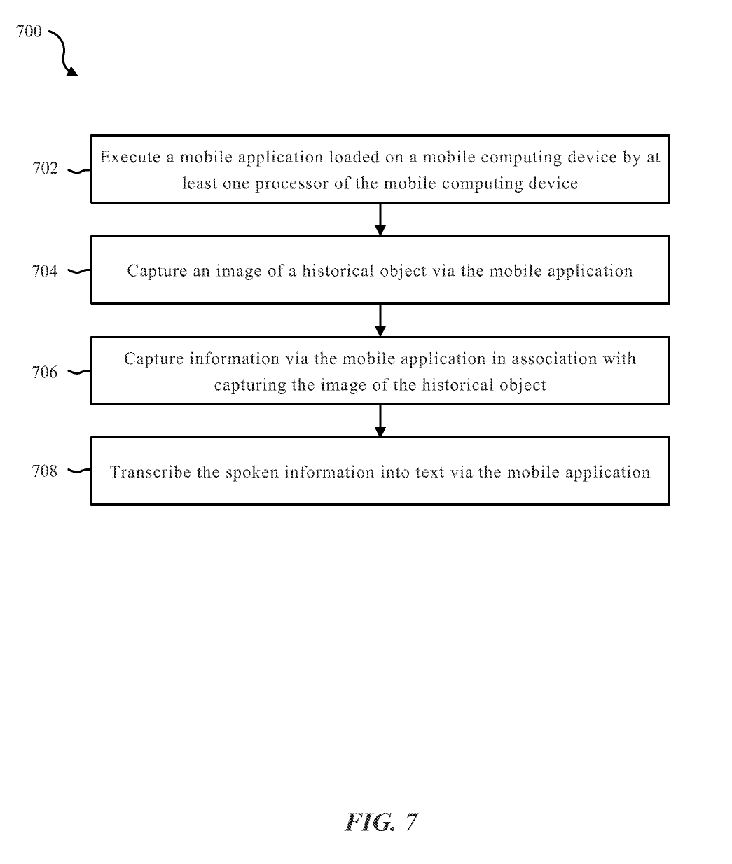

FIG. 7 is a flow diagram illustrating one embodiment of a method 700 for managing a database of landmark records via a mobile application. In some configurations, the method 700 may be implemented by the family history module 104 illustrated in FIGS. 1, 2, and/or 3. In some configurations, the method 700 may be implemented by the application 202 illustrated in FIG. 2.

At block 702, a mobile application loaded on a mobile computing device may be executed by at least one processor of the mobile computing device. At block 704, an image of a landmark may be captured via the mobile application. At block 706, information may be captured through typing and/or speech recognition via the mobile application in association with capturing the image of the landmark. At block 708, the spoken information may be transcribed into text via the mobile application.

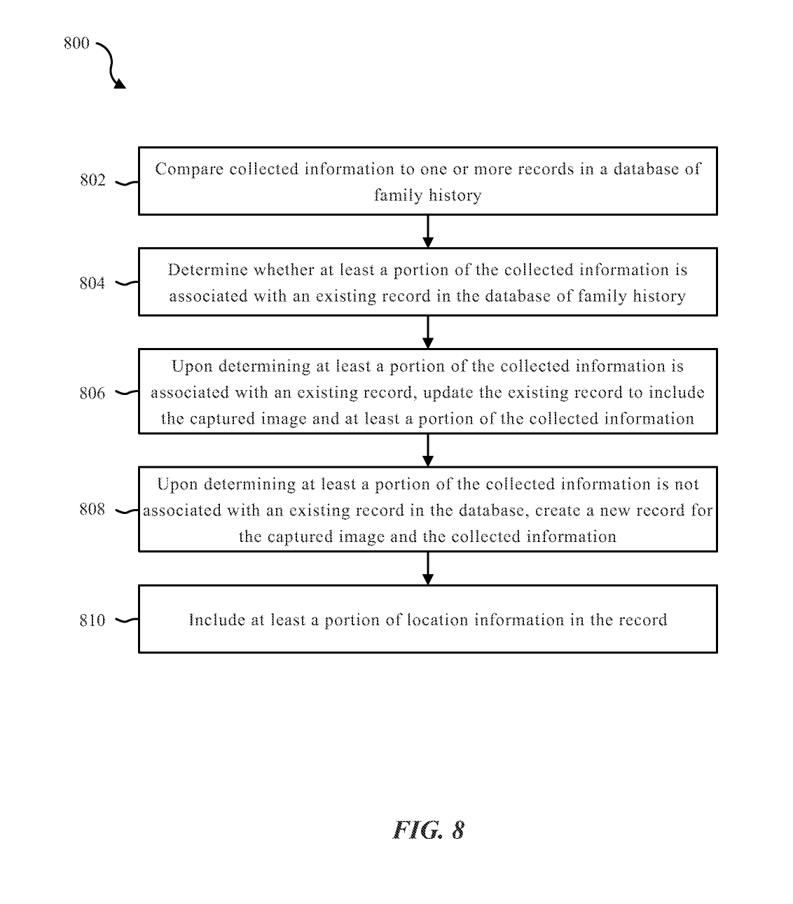

FIG. 8 is a flow diagram illustrating one embodiment of a method 800 for modifying and creating landmark records. In some configurations, the method 800 may be implemented by the family history module 104 illustrated in FIGS. 1, 2, and/or 3. In some configurations, the method 800 may be implemented by the application 202 illustrated in FIG. 2.

At block 802, transcribed information may be compared to one or more records in a database of landmarks. At block 804, it may be determined whether at least a portion of the transcribed information is associated with an existing record in the database of landmarks. At block 806, upon determining at least a portion of the transcribed information is associated with an existing record, the existing record may be updated to include the captured image and/or at least a portion of the transcribed information. At block 808, upon determining at least a portion of the transcribed information is not associated with an existing record in the database, a new record may be created for the captured image and/or the transcribed information. At block 810, at least a portion of location information may be included in the record associated with the image of the landmark. At block 812, at least a portion of manually-entered information may be included in the record associated with the image of the landmark.

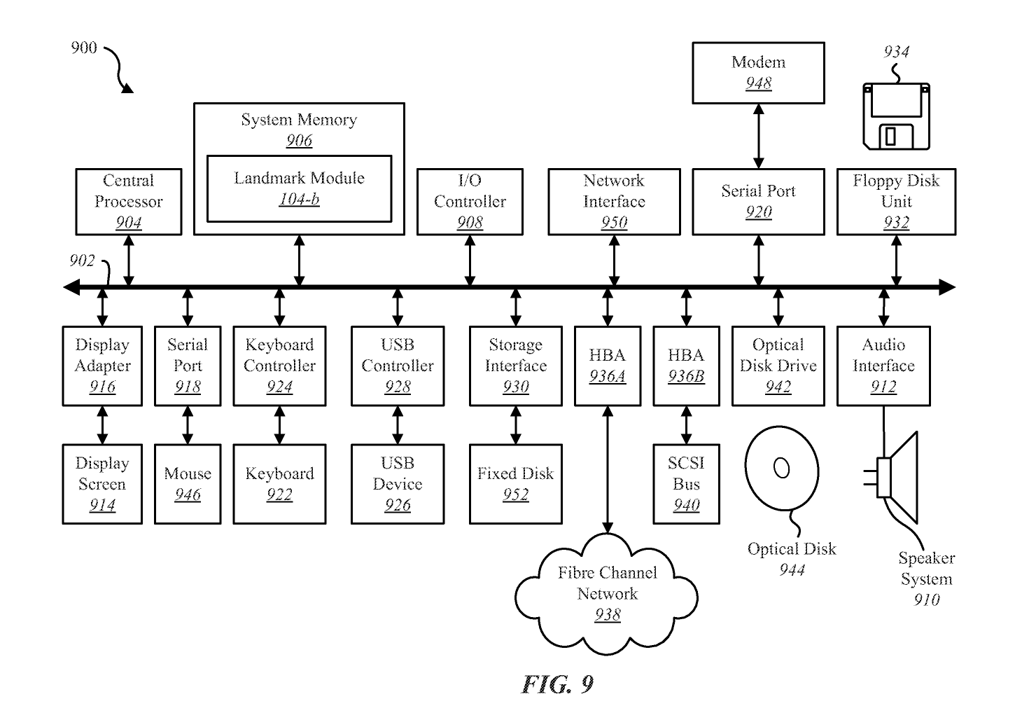

FIG. 9 depicts a block diagram of a computer system 900 suitable for implementing the present systems and methods. The depicted computer system 900 may be one example of a server 206 depicted in FIG. 2. Alternatively, the system 900 may be one example of a device 102 depicted in FIGS. 1, 2, and/or 6. Computer system 900 includes a bus 902 which interconnects major subsystems of computer system 900, such as a central processor 904, a system memory 906 (typically RAM, but which may also include ROM, flash RAM, or the like), an input/output controller 908, an external audio device, such as a speaker system 910 via an audio output interface 912, an external device, such as a display screen 914 via display adapter 916, serial ports 918 and mouse 946, a keyboard 922 (interfaced with a keyboard controller 924), multiple USB devices 926 (interfaced with a USB controller 928), a storage interface 930, a host bus adapter (HBA) interface card 936A operative to connect with a Fibre Channel network 938, a host bus adapter (HBA) interface card 936B operative to connect to a SCSI bus 940, and an optical disk drive 942 operative to receive an optical disk 944. Also included are a mouse 946 (or other point-and-click device, coupled to bus 902 via serial port 918), a modem 948 (coupled to bus 902 via serial port 920), and a network interface 950 (coupled directly to bus 902).

Bus 902 allows data communication between central processor 904 and system memory 906, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a family history module 104-b to implement the present systems and methods may be stored within the system memory 906. The family history module 104-b may be one example of the family history module 104 depicted in FIGS. 1, 2, and/or 3. Applications resident with computer system 900 are generally stored on and accessed via a non-transitory computer readable medium, such as a hard disk drive (e.g., fixed disk 952), an optical drive (e.g., optical drive 942), or other storage medium. Additionally, applications can be in the form of electronic signals modulated in accordance with the application and data communication technology when accessed via network modem 948 or interface 950.

Storage interface 930, as with the other storage interfaces of computer system 900, can connect to a standard computer readable medium for storage and/or retrieval of information, such as a fixed disk drive 952. Fixed disk drive 952 may be a part of computer system 900 or may be separate and accessed through other interface systems. Modem 948 may provide a direct connection to a remote server via a telephone link or to the Internet via an internet service provider (ISP). Network interface 950 may provide a direct connection to a remote server via a direct network link to the Internet via a POP (point of presence). Network interface 950 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 9 need not be present to practice the present systems and methods. The devices and subsystems can be interconnected in different ways from that shown in FIG. 9. The operation of at least some of the computer system 900 such as that shown in FIG. 9 is readily known in the art and is not discussed in detail in this application. Code to implement the present disclosure can be stored in a non-transitory computer-readable medium such as one or more of system memory 906, fixed disk 952, or optical disk 944. The operating system provided on computer system 900 may be MS-DOS®, MS-WINDOWS®, OS/2®, UNIX®, LINUX®, iOS®, ANDROID®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for managing family history records, the method comprising:
collecting, via a processor of a remote handheld device, family history data;
comparing, via the processor, the collected family history data to data in an existing family history record; and
upon determining the collected family history data matches at least a portion of the data in the existing family history record, updating, via the processor, the existing family history record to include at least a portion of the collected family history data.

2. The method of claim 1, further comprising:
upon determining the collected family history data does not match at least a portion of data in any existing family history record, creating a new family history record using at least a portion of the collected family history data.

3. The method of claim 1, wherein collecting family history data comprises collecting an image of a historical object.

4. The method of claim 1, wherein collecting family history data comprises collecting genealogical location information of a historical object.

5. The method of claim 1, wherein collecting family history data comprises collecting data entered on the remote handheld device by the user.

6. The method of claim 1, wherein collecting family history data comprises collecting an audio recording of orally conveyed information regarding a historical object.

7. The method of claim 6, further comprising:
transcribing the audio recording via the processor.

8. A computing device configured to manage family history records, comprising:
a processor;
memory in electronic communication with the processor; and
instructions stored in the memory, the instructions being executable by the processor to:
collect family history data;
compare the collected family history data to data in an existing family history record; and
upon determining the collected family history data matches at least a portion of the data in the existing family history record, update the existing family history record to include at least a portion of the collected family history data.

9. The method of claim 8, further comprising:
upon determining the collected family history data does not match at least a portion of data in any existing family history record, create a new family history record using at least a portion of the collected family history data.

10. The computing device of claim 8, wherein the instructions to collect family history data comprise instructions to collect an image of a historical object.

11. The computing device of claim 8, wherein the instructions to collect family history data comprise instructions to collect genealogical location information of a historical object.

12. The computing device of claim 8, wherein the instructions to collect family history data comprise instructions to collect data entered on the computing device by the user.

13. The computing device of claim 8, wherein the instructions to collect family history data comprise instructions to collect an audio recording of orally conveyed information regarding a historical object.

14. The computing device of claim 13, wherein the instructions are executable by the processor to transcribe the audio recording.

15. A computer-program product for managing, by a processor, family history records, the computer-program product comprising a non-transitory computer-readable medium storing instructions thereon, the instructions being executable by the processor to:
collect family history data;
compare the collected family history data to data in an existing family history record; and
upon determining the collected family history data matches at least a portion of the data in the existing family history record, update the existing family history record to include at least a portion of the collected family history data.

16. The computer-program product of claim 15, wherein the instructions are executable by the processor to:
upon determining the collected family history data does not match at least a portion of data in any existing family history record, create a new family history record using at least a portion of the collected family history data.

17. The computer-program product of claim 15, wherein the instructions to collect family history data comprises instructions executable by the processor to perform at least one of collect an image of a historical object, collect location information of the historical object, collect data entered on a remote handheld device by the user, collect an audio recording of orally conveyed information regarding the historical object, and upon determining the audio recording is collected, transcribe the audio recording.

18. A computer-implemented method for managing family history records, the method comprising:
accessing, via a processor of a remote handheld device, an existing family history record prior to collecting family history data;
collecting, via the processor, the family history data;
automatically associating the collected family history data with the existing family history record accessed prior to collecting the family history data.

19. The method of claim 18, wherein collecting family history data comprises at least one of collecting an image of a historical object, collecting location information of the historical object, collecting data entered on the remote handheld device by the user, and collecting an audio recording of orally conveyed information regarding the historical object.

20. The method of claim 19, further comprising:
transcribing the audio recording via the processor.
